(19) United States
(12) Patent Application Publication
(10) Pub. No.: US 2024/0362093 A1
(43) Pub. Date: Oct. 31, 2024

(54) QUERY RESPONSE USING A CUSTOM CORPUS

(71) Applicant: GOOGLE LLC, Mountain View, CA (US)

(72) Inventors: Hao Zhou, Redwood City, CA (US); Jamie Hall, Sydney (AU); Xinying Song, Kirkland, WA (US); Sahitya Potluri, Sunnyvale, CA (US); Yu Du, Sunnyvale, CA (US); Heng-Tze Cheng, Mountain View, CA (US); Quoc Le, Sunnyvale, CA (US); Ed H. Chi, Los Altos, CA (US)

(21) Appl. No.: 18/231,606

(22) Filed: Aug. 8, 2023

Related U.S. Application Data
(60) Provisional application No. 63/462,746, filed on Apr. 28, 2023.

(51) Int. Cl. G06F 9/54; G06F 16/242

(52) U.S. Cl. CPC G06F 9/547; G06F 16/243

(57) ABSTRACT

At least utilizing a custom corpus of documents to condition a large language model (LLM) when generating a response to a user query. In some implementations, a user query associated with a client device is received. An API query for an external application is generated by an LLM based on the user query. The external application has access to a custom corpus of documents comprising a plurality of documents. The external application is queried using the API query. Data representative of one or more documents in the custom corpus of documents is received from the external application in response to the API query. The LLM generates a response to the query that is conditioned on the data representing one or more of the documents in the custom corpus of documents received from the external application. The response to the user query is caused to be rendered on the client device.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that that reflects NL content and/or other content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, LLMs are typically trained on a large volume of generic textual data. To specialize an LLM, e.g., for a specific set of textual data or user, LLM parameters are typically fine-tuned on a new set of training data. This can be computationally costly, and, where limited datasets for the fine-tuning are available, may result in inaccurate responses being generated by the LLM or overfitting on the training data used to fine-tune the LLM. The computational cost of retraining an LLM can also make it undesirable to retrain the LLM when the data it has be fine-tuned on has been updated, which can result in LLM responses becoming inaccurate over time. Furthermore, LLMs are typically extremely large models, with billions of parameters, and consequently cannot easily fit locally onto user devices with a constrained memory space, e.g., mobile devices and/or IoT devices.

### SUMMARY

Implementations disclosed herein are directed to at least utilizing a custom corpus of documents to condition an LLM when generating a response to a user query (e.g., a user submitted query or an automatically generated query) for rendering (e.g., audibly and/or graphically) by a user device. The LLM processes a received user query to generate one or more API queries for one or more external applications that each has access to a respective custom corpus of documents. The one or more external applications select one or more relevant documents from their respective document corpus based on the API query and return data representative of the selected one or more documents (e.g., a copy of the document, a snippet of the document and/or an embedding representing the document or a snippet thereof) to the LLM. The LLM uses data representing at least one of the selected documents as contextual data when generating a response to the user query.

In these and other manners, the LLM can generate query responses that are tailored to particular set of documents (i.e., the documents included in the custom corpus) without any fine-tuning or additional training of the LLM. Furthermore, as the set of documents in the custom corpus is updated or edited, the responses generated by the LLM when receiving queries will be updated accordingly without any further training (e.g., fine-tuning) of the LLM. This enables the query responses to be tailored to the custom corpus without any having to perform any of the aforementioned fine-tuning or additional training of the LLM.

The systems and methods described herein may also provide a client device with limited computational capabilities (e.g., limited processing power, memory or battery power) the ability to tailor LLM responses on user documents stored on the client device (i.e. a custom corpus of documents associated with a user), without having to run or store the LLM locally on the client device. By providing access control information to the LLM when submitting a query, the client device can allow the LLM to access locally stored documents in a private custom corpus in order to tailor query responses to the user.

In some implementations, an LLM can include at least hundreds of millions of parameters. In some of those implementations, the LLM includes at least billions of parameters, such as one hundred billion or more parameters. In some additional or alternative implementations, an LLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). However, and as noted, it should be noted that the LLMs described herein are one example of generative machine learning models are not intended to be limiting.

A custom corpus of documents may include a plurality of documents that are managed by an entity/user via an external application. A custom corpus of documents may comprise documents or other data that were not used in the training of an LLM. An example of a custom corpus is a set of private/personal user documents or data. A further example of a custom corpus is a set of internal documents or data of an organization/business/external application. A custom corpus may include documents relating to a specific subject or topic, e.g., an area of research, a historical era, a specific person, a geographic area or the like. Additionally, or alternatively, a custom corpus may include documents or data relating to a product or product line, e.g., user manuals, design documents, product specifications, product test data, product reviews, or the like. Additionally, or alternatively, a custom corpus may include documents or data relating to a business or organization, e.g., sales documents, advertisements, reports, reviews or the like. Many other examples are possible.

In some implementations, the entity/user that manages the external application and/or custom corpus of documents may be a third-party entity/user that is a distinct entity from a first-party entity/user that trains or manages the LLM. Accordingly, in these implementations, the external application and custom corpus of documents may be referred to as a third-party external application and a third-party custom corpus of documents, respectively. Put another way, the first-party entity/user can train or manages the LLM, but enable the third-party entity/user to leverage the capabilities of the LLM. In leveraging the capabilities of the LLM, the third-party entity/user can provide the LLM access to the third-party external application and the third-party custom corpus of documents via the third-party external application, or the third-party entity/user can provide the LLM access directly to the third-party custom corpus of documents. As a result, the LLM can not only generate responses based on data that was utilized in training the LLM, but also based on data that is present in the third-party custom corpus of documents.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of generating, using an LLM and a custom corpus of documents, an NL based response to a query, and causing the NL based response to be rendered.

FIG. 3 depicts a flowchart illustrating a further example method of generating, using an LLM and a custom corpus of documents, an NL based response to a query, and causing the NL based response to be rendered.

FIG. 4 depicts a flowchart illustrating an example method of selecting documents from a custom corpus in response to a query and providing data representative of the selected one or more documents in the custom corpus to an LLM.

FIG. 5A and FIG. 5B each depict an example client device rendering a graphical interface that includes an example response generated using a custom corpus rendered in response to a query.

FIG. 6 depicts an example architecture of a computing device, in accordance with various implementations.

### DETAILED DESCRIPTION

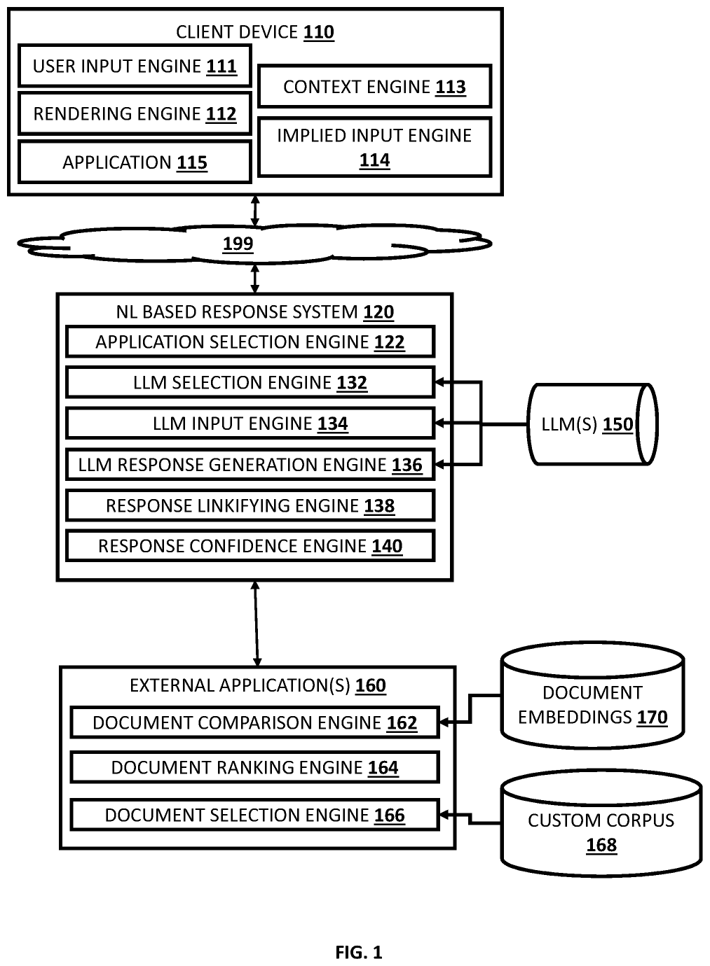

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and external application(s) 160. Although illustrated separately, in some implementations all or aspects of the NL based response system 120 and all or aspects of external application(s) 160 can be implemented as part of a cohesive system. The term “external application” is preferably used to connote an application that is external to the NL based response system 120, for example that is controlled/managed by a different third-party entity/user in comparison with a first-party entity/user that controls/manages the NL based response system 120.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based response) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “how close is our nearest office” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users of a household, a workplace, or the like).

The NL based response system 120 is illustrated as including an application selection engine 122, an LLM selection engine 132, an LLM input engine 134, an LLM response generation engine 136, a response linkifying engine 138, a response confidence engine 140, and an interaction engine 142. Some of the engines can be omitted in various implementations.

The application selection engine 122 can, in response to receiving a query, determine whether the query refers to, or is otherwise associated with, a custom corpus of documents managed by the external application(s) 160 or data contained within the custom corpus of documents managed by the external application(s) 160. In response to determining that the query refers to, or is otherwise associated with, a custom corpus of documents managed by an external application 160, the application selection engine 122 can cause an LLM to generate an API query for the external application.

The LLM selection engine 132 can, in response to receiving a query, determine which, if any, of multiple generative model(s) (LLM(s) and/or other generative model(s)) to utilize in generating response(s) to render responsive to the query. For example, the LLM selection engine 132 can select none, one, or multiple generative model(s) to utilize in generating response(s) to render responsive to a query.

The LLM input engine 134 can, in response to receiving a query, generate LLM input that is to be processed using an LLM in generating an NL based response to the query. As described herein, such content can include query content that is based on the query and/or additional content. The additional content included in the LLM input may additionally comprise contextual data for conditioning the LLM when providing a response, data representative of one or more documents from a custom corpus (e.g., a copy of the document, a snippet of the document and/or an embedding representing the document or a snippet thereof), and/or other content.

The LLM response generation engine 136 can process LLM input, that is generated by the LLM input engine 134, and using an LLM, to generate LLM output. The LLM output can include, for example, a probability distribution over a sequence of tokens, such as words, phrases, or other semantic units, that are predicted to be responsive to a query. Further, the LLM response generation engine 136 can determine an NL based response based on the LLM output. For instance, the LLM response generation engine 136 can perform matrix multiplication using the weights and/or parameters of the LLM to determine a plurality of candidate segments and based on the probability distribution over the sequence of tokens. In this instance, and based on the probability distribution, the LLM response generation engine 136 can select one or more of the plurality of candidate segments for inclusion in the NL based response.

The response linkifying engine 138 can linkify all or portions of an NL based response generated by the LLM response generation engine 136. Linkifying the NL based response may comprise inserting one or more links or document identifiers in the response to documents in the custom corpus of documents that are relevant to the user query.

The response confidence engine 140 may determine a confidence score for an NL based response generated by the LLM response generation engine 136. If the confidence score is above a threshold score, the NL based response is provided to the client device for output to the user. If the confidence score is below the threshold score, the NL based response system may cause the client device to request further information and/or clarifications.

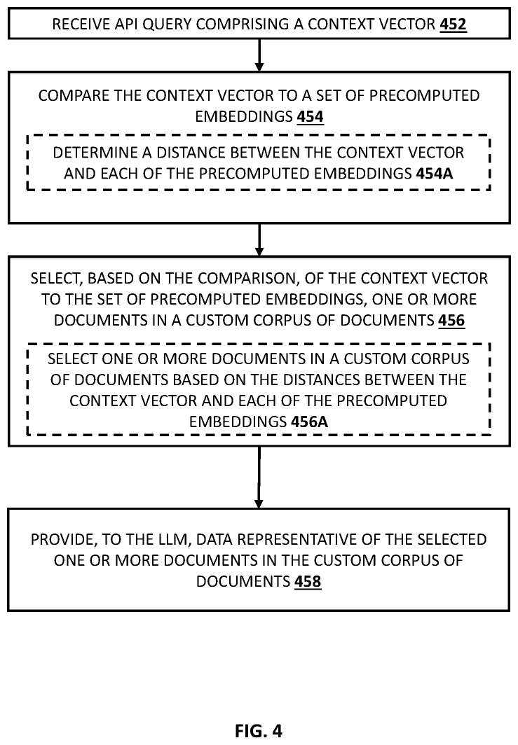

External application(s) 160 is illustrated as including a document comparison engine 162, a document ranking engine 164, and a document selection engine 166. Some of the engines can be omitted in various implementations. In various implementations, the external application(s) 160 can perform all or aspects of method 400 of FIG. 4. The external application(s) 160 may be located remotely from the NL based response system 120 and accessed by the NL based response system 120 across a network. For example, the external application(s) 160 may be under the control of a third-party entity (e.g., an entity separate from the entities managing the NL based response system 120, i.e. the “first-party”). As another example, the external application(s) 160 may be local to the client device 110, e.g., operating on the client device 110, with the NL based response system 120 being remote from both the client device 110 and the external application 160. This can be advantageous when the custom corpus 168 is a set of user documents stored on the client device 110, but the client device 110 computational capabilities (e.g., processing speed, available memory and/or power usage/availability) are suited to running the NL base response system 120, e.g., due to the size of the LLM.

The document comparison engine 162 can, for example, utilize document embeddings 170 of documents in the custom corpus 168 of documents accessible to the external application(s) 160 to compare a user query to documents in the custom corpus 168. The document ranking engine 164 can rank documents in the custom corpus 168 based on the comparison performed by the document comparison engine 162. The document selection engine 166 can select one or more documents from the custom corpus 168 based on the comparison performed by the document comparison engine 162 and/or the document ranking performed by the document ranking engine 164.

The custom corpus 168 includes a plurality of documents that are managed/under control of an entity (such as an organization) or user(s). The entity/user managing/controlling the custom corpus may be distinct from the entity controlling/managing the NL based response system, 120 (the first-party), e.g., be a third-party. The custom corpus 168 may include documents that were not part of the training data on which the LLM of the NL based response system 120 was trained.

In various implementations, the external application(s) 160 and/or the custom corpus 168 may have restricted access, i.e., only users or entities with access rights may access, edit and/or query the custom corpus of documents. A hierarchy of access rights may be provided that grants different levels of access to different sets of users/entities. For example, a first set of users/entities may have the right to query the custom corpus of documents 168, and a second set of users may additionally have the right to edit the custom corpus of documents 168. As another example, a first set of users/entities may have the right to query a first custom corpus of documents associated with the external application(s) 160, but a second set of users may have the right to query a first custom corpus of documents and a second custom corpus of documents associated with the external application(s) 160. The external application(s) 160 may manage access to the custom corpus 168 based on the access rights of users/entities interacting with the custom corpus 168. For instance, different access control data, such as tokens or keys, associated with client device 110 or a user of the client device 110 can be passed along with the query to enable access the external application(s) 160 and/or the custom corpus 168 of documents based on the different levels of access to the different sets of users/entities.

The document embeddings 170 are latent representations of the documents (e.g., vectors in an embedding space or lower-dimensional latent space) that each represent a respective document or set of documents in the custom corpus. The embeddings may be generated from an intermediate output of an LLM, such as output of an intermediate layer of the LLM that has processed the document. Alternatively, a dedicated encoder model, such as an encoder of a variational autoencoder (VAE) model may be used to generate the document embeddings 170.

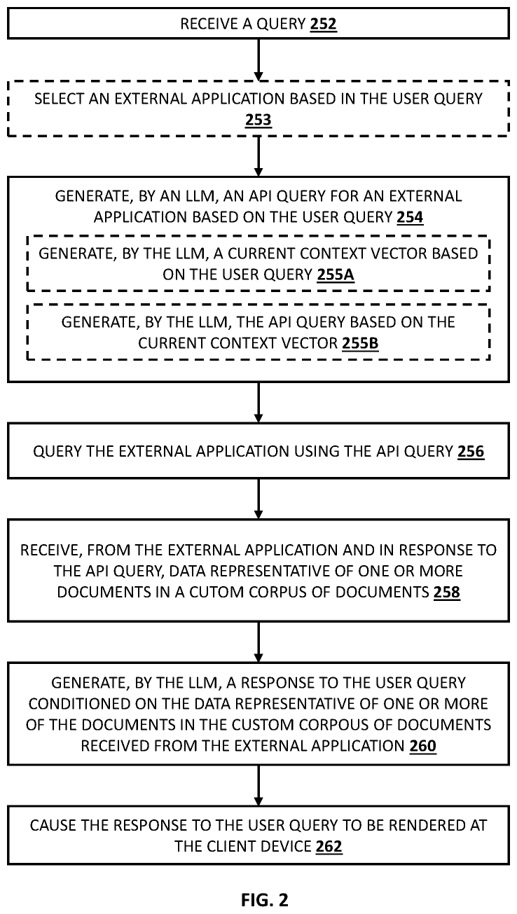

Although certain functionality is described with respect to the various systems and engines depicted in FIG. 1, it should be understood that is for the sake of illustrating techniques contemplated herein and is not meant to be limiting. Additional, or alternative, functionality of the various systems and engines depicted in FIG. 1 is described in more detail herein (e.g., with reference to FIGS. 2-4).

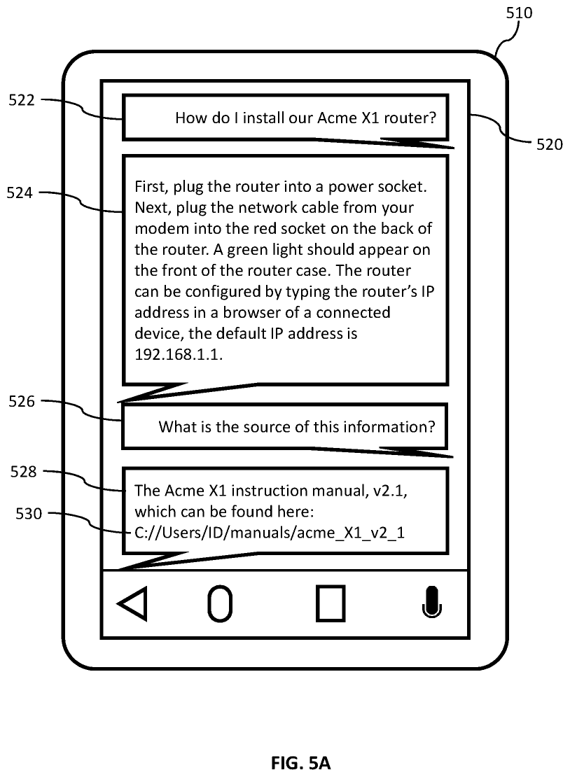

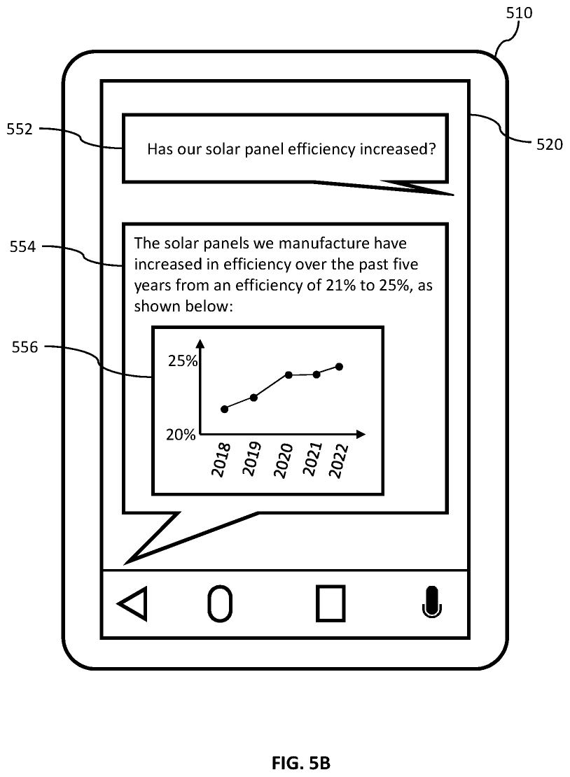

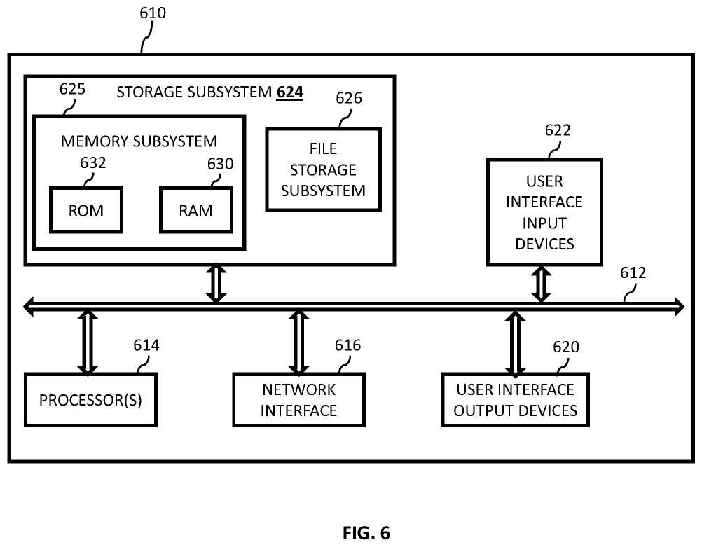

Turning now to FIG. 2, a flowchart is depicted that illustrates an example method 200 of generating, using an LLM and a custom corpus of documents, an NL based response to a query, and causing the NL based response to be rendered. For convenience, the operations of the method 200 are described with reference to a system that performs the operations. This system of the method 200 includes one or more processors, memory, and/or other component(s) of computing device(s) (e.g., client device 110 of FIG. 1, client device 610 of FIG. 6, and/or client device 510 of FIGS. 5A and 5B, one or more servers, and/or other computing devices). Moreover, while operations of the method 200 are shown in a particular order, this is not meant to be limiting. One or more operations may be reordered, omitted, and/or added.

At block 252, the system receives a query. The query can be one formulated based on user interface input at a client device, such as typed input, voice input, input to cause an image to be captured or selected, etc. The query can be, for example, a voice query, a typed query, an image-based query, a multimodal query (e.g., that includes voice input and an image), or an inferred/parameterless query. In some implementations, when the query includes content that is not in textual format, the system can convert the query to a textual format or other format. For example, if the query is a voice query the system can perform automatic speech recognition (ASR) to convert the query to textual format. As another example, assume the query is a multimodal query that includes an image of an avocado and a voice input of “is this healthy”. In such an example, the system can perform ASR to convert the voice input to text form, can perform image processing on the image to recognize an avocado is present in the image, and can perform co-reference resolution to replace “this” with “an avocado”, resulting in a textual format query of “is an avocado healthy”.

The query can alternatively be an implied query, such as one formulated and/or submitted independent of any user input directed to formulating the implied query. For example, the query can be an implied query that is automatically generated based on profile data and that is automatically submitted. For instance, the implied query can be “machine learning”, based on profile data indicating interest in machine learning topic(s). As another example, the query can be an implied query that is automatically generated and/or automatically submitted based on a current and/or recent context. As yet another example, the query can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

In some implementations, the user query is accompanied by access control data, such as a token or key, for allowing an LLM to access external application(s) and/or a custom corpus of documents. This can allow the system to access one or more access restricted custom corpora of documents. In some versions of those implementations, the access control data may have a limit to the number of times it can be used by the system, e.g., only allow access to the custom corpus once. In additional or alternative versions of those implementations, the access control data may be time-limited, i.e., provide access to the custom corpus for a predetermined time after the user query is submitted.

In some implementations, at optional block 253, the system selects one or more external applications from a plurality of external applications accessible by the LLM based on the user query and/or contextual information (e.g., a current or recent context of the client device or user session). The system may interface with multiple external applications, each of which is associated with/has access to a respective custom corpus of documents or a respective custom corpora of documents. For example, each custom corpus of documents may relate to a respective subgroup of an organization, a respective user or other individual, and/or a respective topic/subject. In some implementations, one or more of the external applications (e.g., each external application) may be a third-party application, i.e. an application that is managed by/under control of a different entity than the system implementing the LLM.

The user query may be used to select one or more of the external applications to query for documents relevant to the user query. For example, the user query may be processed by an LLM to identify one or more topics, subjects, keywords and/or entities referred to in the user query (either explicitly or implicitly). Based on the identified topics, subjects, keywords and/or entities referred to in the user query, the system may select one or more of the external applications to query. The selection may, for example, be based on matching one or more of the identified topics, subjects, keywords and/or entities referred to in the user query to metadata associated with each of the external applications, such as a description of the custom corpus associate with each external application. The external application may, for example, be selected based on a state of the client device; one or more further queries associated with the client device; and/or user data associated with a user of the client device.

Alternatively or additionally, contextual information may be used to select one or more of the external applications to query for documents relevant to the user query. The contextual information may, for example, comprise a client device context, such as a client device location, orientation, and/or network status. The contextual information may alternatively or additionally comprise a current state of a query session (e.g., considering one or more recent queries of the query session or other interactions).

At block 254, the system uses an LLM to generate an API query for an external application based on the user query. The LLM may have been trained to generate such API queries from a user query directly, e.g., the output from the LLM is an API query based on the user query. Alternatively, the system may maintain one or more template API queries for the external application(s) which can be populated by the output of the LLM, e.g., the LLM can identify topics, subjects, keywords and/or entities referred to in the user query and populate the template API query with the identified topics, subjects, keywords and/or entities.

Where the user query provided at block 252 includes access control data, the LLM may incorporate the access control data into the API query, e.g., incorporate a token or key received in the user query into the API query. Alternatively, the LLM may itself be assigned a set of access control data by an organization. Such access control data may be incorporated into the API query.

In some implementations, the block 254 includes subblock 254A, in which the LLM generates a current context vector based on the user query. The current context vector may be an embedded representation of the user query, e.g., an intermediate output of the LLM/output of an intermediate layer of the LLM, and may further be based on recent user queries provided to the system, user data (such as a user identity or profile), a client device state, and/or other contextual information.

In some versions of those implementations, the block 254 includes subblock 254B, in which the LLM generates the API query based on the current context vector. The API query may, for example, comprise the current context vector determined by the LLM.

In some implementations, the system may use the LLM to generate a plurality of API queries based on the user query, each API query directed towards a respective external application of a plurality of external applications.

At block 256, the system queries the external application using the API query. One or more external applications may be queried using respective API queries. In implementations where the external application is located remotely from the system, the system transmits the API query across a network to the external application. In implementations where the external application is local to the system, the API query may be transmitted directly to the external application.

The external application identifies one or more documents in the custom corpus associated with the external application using the API query. Examples methods of identifying the one or more documents in the custom corpus that may be performed by the external application are described in further detail herein (e.g., with reference to FIG. 4).

In some implementations, the external application may utilize the access control data provided in the API query to determine whether the user of the client device and/or the LLM has permission to access the custom corpus of documents, as described in further detail herein (e.g., with reference to FIG. 4).

At block 258, the system receives a response to the API query from the external application. The response includes data representative of one or more documents in the custom corpus of documents accessible by the external application that are selected by the external application based on their relevance to the user query as described in further detail herein (e.g., with reference to FIG. 4). In implementations where the external application is remote from the system, the response may be received over a network. In implementations where the external application is local to the system, the response may be received directly from the external application.

The data representative of one or more documents may comprise a copy of one or more of the documents identified by the external application, e.g., the full text of the document. Additionally, or alternatively, the data representative of one or more documents may comprise a textual summary of one or more of the documents identified by the external application, e.g., an abstract of the document. Additionally, or alternatively, the data representative of one or more documents may comprise a snippet/extract of one or more of the documents identified by the external application, e.g., a portion of a document identified as relevant to the user query. Additionally, or alternatively, the data representative of one or more documents may comprise one or more embeddings of one or more of the documents identified by the external application, e.g., a vector in an embedding space representing the document. The use of embeddings to condition the LLM can prevent private/restricted access documents in the custom corpus from being transmitted from the external application to the system running the LLM.

At block 260 the system generates a response to the user query using the LLM. The LLM is conditioned on the data representative of one or more of the documents in the custom corpus of documents received from the external application, e.g., data representing one or more of the received documents may be input into the LLM as contextual data for generating the response.

In some implementations, all of the received data representative of one or more of the documents relevant to the query is used to condition the LLM. Alternatively, the data representative of one or more of the documents in the custom corpus of documents used to condition the LLM may be a subset of the data received from the external application, e.g., the system may select one or more of the received documents (or a portion of the data representation thereof) to condition the LLM. The selection may be based on contextual data of the query-submitting device, for example a user identity/profile of the user submitting the request, a device location, a recent interaction history, or the like.

At block 262, the system causes the response to the user query to be rendered at the user device. For example, the system can cause the response to be rendered graphically in an interface of an application of a client device via which the query was submitted. As another example, the system can additionally or alternatively cause the response to be audibly rendered via speaker(s) of a client device via which the query was submitted.

In some implementations, the system may cause one or more links to documents in the custom corpus that have been identified as relevant to the query to be rendered as part of the response. In additional or alternative implementations, the system may cause one or more document identifiers for documents in the custom corpus that have been identified as relevant to the query to be rendered as part of the response

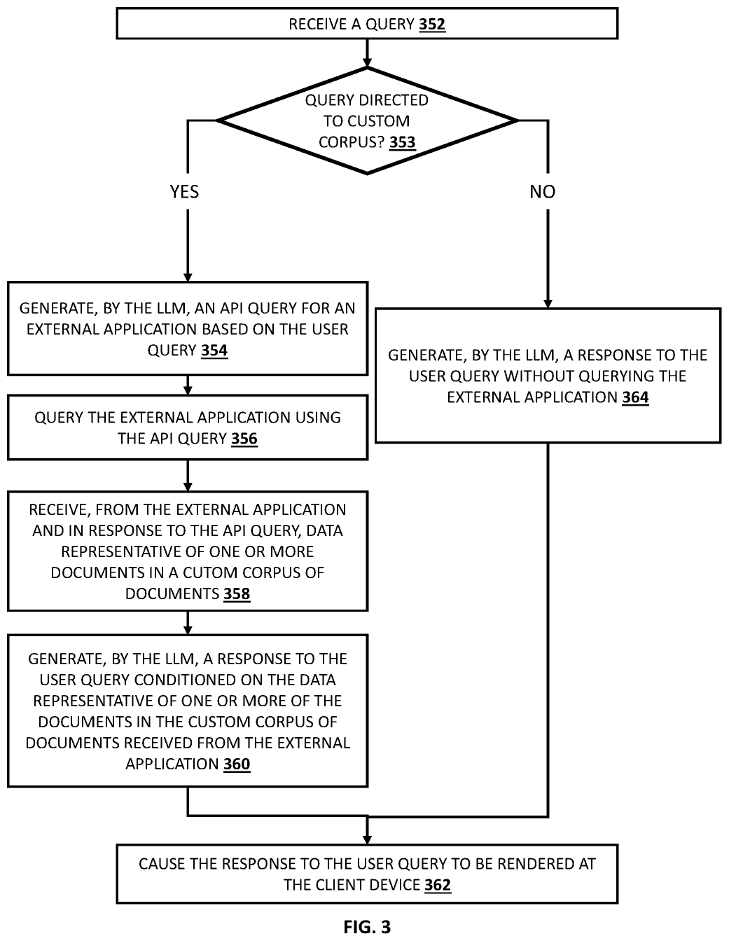

Turning now to FIG. 3, a flowchart is depicted that illustrates an example method 300 of generating, using an LLM and a custom corpus of documents, an NL based response to a query, and causing the NL based response to be rendered. For convenience, the operations of the method 300 are described with reference to a system that performs the operations. This system of the method 300 includes one or more processors, memory, and/or other component(s) of computing device(s) (e.g., NL based response system 120 of FIG. 1, one or more servers, and/or other computing devices). Moreover, while operations of the method 300 are shown in a particular order, this is not meant to be limiting. One or more operations may be reordered, omitted, and/or added. Some of the operations depicted in FIG. 3 are the same or similar to those described above in relation to FIG. 2.

At block 352, the system receives a query. The query can be one formulated based on user interface input at a client device, such as typed input, voice input, input to cause an image to be captured or selected, etc. The query can alternatively be an implied query, such as one formulated and/or submitted independent of any user input directed to formulating the implied query. Examples of such queries are described above in relation to block 252 of FIG. 2

At block 353, the system determines if the query is directed to one or more custom corpus accessible by the system. The system may process the query to determine a user intent, for example using the LLM to identify entities or subjects referred to explicitly or implicitly in the query. Further, the system may determine whether the query is directed to one or more custom corpus accessible by the system based on the determined intent. Additional contextual information (e.g. a user profile or identity, a recent query/interaction history of the user, a location etc.) may be used to make the determination of whether the query is directed to one or more custom corpus accessible by the system.

For example, if a user employed by a particular entity uses the term “our” in a query, the system may infer that the user is referring to the entity, and consequently determine that the query is directed towards a custom corpus managed by the entity. As another example, if a user uses the term “my” in a query, the system may infer that the user is referring to personal documents, and consequently determine that the query is directed towards a personal custom corpus of the user. As a further example, if a user uses the term “here” in a query, the system may infer that the user is referring to the user current location, and consequently determine that the query is directed towards a custom corpus associated with the user location (e.g., a custom corpus of the user's workplace if the user location corresponds to the user's workplace, a custom corpus of that is personal to the user if the user location corresponds to the user's primary dwelling). Many other examples are possible.

In some implementations, a custom corpus of documents may be associated with a plurality of tags (e.g. keywords and/or labels). The tags describe properties/contents of the custom corpus of documents. The system may compare keywords extracted from the query to the plurality of tags of a custom corpus and, in response to matching one or more keywords extracted from the query to one or more of the plurality of tags of a custom corpus, determine that the query is directed towards that custom corpus.

If the system determines that the query is directed to one or more custom corpus accessible by the system (e.g., via one or more external applications), the method proceeds to block 354. If the system determines that the query is not directed to one or more custom corpus accessible by the system, the method proceeds to block 364.

At block 354, the system uses an LLM to generate an API query for an external application that has access to a custom corpus of documents. The API query is based on the user query, as described with respect to block 254 of FIG. 2.

At block 356, the system queries the external application using the API query, as described in relation to block 256 of FIG. 2.

At block 358, the system receives data representing one or more documents in a custom corpus of documents, as described above in relation to block 258 of FIG. 2.

At block 360, the system generates a response to the user query conditioned on data representing one or more of the documents in the custom corpus received from the external application, as described above in relation to block 260 of FIG. 2.

At block 364, the system generates a response to the user query using the LLM without querying the external application. The LLM may generate the response based on the user query and any related contextual information, e.g., directly, without causing an external application to search for relevant documents in the custom corpus of documents associated with the external application.

At block 362, the system causes the response to the user query to be rendered at the user device, as described above in relation to block 262 of FIG. 2.

Turning now to FIG. 4, a flowchart is depicted that illustrates an example method 400 of selecting documents from a custom corpus in response to a query and providing data representative of the selected one or more documents in the custom corpus to an LLM. For convenience, the operations of the method 400 are described with reference to a system that performs the operations. This system of the method 400 includes one or more processors, memory, and/or other component(s) of computing device(s) (e.g., external application 160 of FIG. 1, one or more servers, and/or other computing devices). Moreover, while operations of the method 400 are shown in a particular order, this is not meant to be limiting. One or more operations may be reordered, omitted, and/or added.

At block 452, the system receives an API query comprising a context vector representing a user query. The API query may originate from an LLM, as described herein (e.g., in relation to FIGS. 2 and 3). In some implementations, the API query may be received over a network from a remote NL based response system. In additional or alternative implementations, the API query may be received from a local NL based response system, e.g. an NL based response system operating on the same device/computing system as the external application.

In some implementations, the API query may include access control data, such as a token or key. The system may compare the access control data in the API query to access control data associated with a custom corpus to determine if the entity sending the query has permission to access the custom corpus. If the access control data in the API query matches the access control data associated with a custom corpus, then the system proceeds to block 454. If the access control data does not match the access control data associated with a custom corpus, then the system prevents access to the custom corpus.

At block 454, the system compares the context vector to a set of precomputed embeddings, each embedding representing a respective document in the custom corpus of documents. Each precomputed embedding, or each precomputed embedding in a subset of the embeddings, is compared with the context vector

Each precomputed embedding comprises a vector in an embedding space that is representative of the contents of a corresponding document in the custom corpus. The embedding vectors may, for example, be outputs of an encoder model, such as the encoder portion of a variational autoencoder (VAE) model trained on text documents. Additionally, or alternatively, the embedding vectors may be intermediate outputs of a text classification model, e.g. states of a hidden layer of the classification model when classifying the document. Additionally, or alternatively, the embedding vectors may be intermediate outputs of an LLM. Notably, each of the precomputed embeddings can be generated prior to the system receiving the API query.

The precomputed embeddings may be determined continuously, e.g. whenever a new document is added to the custom corpus or an existing document updated, a corresponding embedding is determined. Additionally, or alternatively, the custom corpus may be checked periodically to determine if any new documents have been added or any existing documents have been updated, and corresponding embeddings determined if so.

In some implementations, comparing the context vector to a precomputed embeddings comprises determining a distance in the embedding space between the context vector and the precomputed embedding, as shown in block 454A. A metric may be used to determine the distances between the precomputed document embedding and the context vector. For example, an L1 or L2 distance, correlation, or cosine similarity in embedding space between the precomputed embedding and the context vector may be determined by the external application.

At block 456, the system selects one or more documents from the custom corpus based on the comparison of the context vector to the set of precomputed embeddings. In some implementations, selecting the one or more documents is based on the distances determined at block 454A, as shown in block 456A.

For example, the documents in the custom corpus may be ranked based on their distance to the context vector. Documents may be ranked in order of their respective distance to the context vector, with documents having a respective embedding vector that is closer to the context vector (e.g., in terms of distance in the embedding space) ranked more highly than documents having a respective embedding vector that is further from to the context vector (e.g., in terms of distance in the embedding space). The N top ranked documents may be selected, where N is an integer, e.g. an integer that is 1 or greater than 1, an integer between 3 and 20, such as 10. Additionally, or alternatively, the N top ranked documents satisfying a distance threshold may be selected, e.g. the N top ranked documents within a threshold distance of the context vector in embedding space are selected. If fewer than N documents have embeddings within the threshold distance, then only those documents satisfying the threshold are selected, i.e. fewer than N documents are selected. Additionally, or alternatively, documents satisfying a distance threshold may be selected, e.g. every document within a threshold distance of the context vector in embedding space is selected.

At block 458, the system provides data representative of the selected one or more documents in the custom corpus to the LLM. The data representative of one or more documents may comprise a copy of one or more of the documents identified by the external application, e.g. the full text of the document. Additionally, or alternatively, the data representative of one or more documents may comprise a textual summary of one or more of the documents identified by the external application, e.g. an abstract of the document. Additionally, or alternatively, the data representative of one or more documents may comprise a snippet/extract of one or more of the documents identified by the external application, e.g. a portion of a document identified as relevant to the user query. Additionally, or alternatively, the data representative of one or more documents may comprise one or more embeddings of one or more of the documents identified by the external application, e.g. the precomputed embedding representing the document.

Turning now to FIG. 5A, an example client device 510 is depicted with a display 520 rendering, in response to a query 522, a graphical interface that includes a first query response 524 and, in response to second query 526, a second query response 528 that includes a link 530 to a document in a custom corpus of documents. In this example, the first query 522 requests instructions for performing an operation with a proprietary piece of equipment. The first response 524 provides natural language instructions for performing the operation that are derived from one or more instruction documents in a custom corpus of documents, e.g. a custom corpus of instruction manuals for equipment used by/manufactured by an entity. The first response 524 may be generated using any of the methods described herein, for example, the methods described in relation to FIGS. 2 and 3.

A second, follow on, query 526 may be input by a user that requests the origin of the first response 524. A second response 528 may be provided that includes one or more links 530 to one or more documents in the custom corpus from which the first response 524 was derived. In the example shown, the link 530 is to the instruction manual of the equipment that the first query 522 relates to. However, it should be understood that is not meant to be limiting and that the second response 528 can additionally, or alternatively, include a document identifier for the instruction manual of the equipment that the first query 522 relates to.

In this example, the user explicitly requested the origin of the first response 524, resulting in the link 530 being rendered on the display 520 of the client device 510. However, in some implementations, the natural language response system may cause links to be rendered as part of a query response without an explicit request being provided. Accordingly, it should be understood that the first response 524 can include the second response 528 and/or the link 530 without the user that initially provided the query 522 having to provide the second, follow on, query 526.

Turning now to FIG. 5B, an example client device 510 is depicted with a display 520 rendering, in response to a query 552, a graphical interface that includes a query response 554 that includes a snippet 556 of a document in a custom corpus of documents. In this example, the query 552 requests information regarding properties of a product of an entity (in this case, solar panels manufactured by the entity). The response 554 provides the requested information in the form of a natural language response, as well as including a portion/extract 556 of a relevant document in the custom corpus of documents from which the response was derived. In the example shown, the extract 556 is a graph, though the extract may in general be any diagram, figure or text extract from a relevant document in the custom corpus of documents from which the response was derived. In some implementations, the response may include multiple extracts 556 from one or more relevant documents in the custom corpus of documents.

In some implementations disclosed herein, multiple LLMs are utilized in parallel in generating an NL based response to a query. For example, each of the multiple LLMS can be utilized to generate a corresponding candidate NL based response, but only one of the candidate NL based responses selected for use (e.g., for rendering in response to the query). For instance, one can be selected for use based on it (a) being similar to the greatest quantity of other candidate NL based responses, (b) being similar to at least a threshold quantity of other candidate NL based responses, (c) lacking certain content (e.g., certain term(s)), (d) including certain content (e.g., certain term(s)), (d) having the highest language model score, (e) having a language model score that satisfies a threshold, and/or (f) having or lacking other feature(s).

In some versions of those implementations, one or more of the LLMs that are utilized in parallel can be truly different from other of the LLM(s). For example, a first of the LLMs can be trained differently than a second of the LLMs. Also, for example, each of the LLMs can be trained differently than all other of the LLMs. As another example, a first of the LLMs can have a first architecture that differs from a second architecture of a second of the LLMs. In some additional or alternative versions of those implementations, two or more (e.g., all) of the LLMs that are utilized in parallel are the same (e.g., architecturally and/or training), but different content is processed among the two or more LLMs. For example, a first LLM may be conditioned on a first subset of the data representative of a plurality of documents in the custom corpus and a second LLM may be conditioned on a second subset of the data representative of a plurality of documents in the custom corpus. Utilizing multiple LLMs in parallel for a given query, while optionally selecting a candidate NL based response from only one, can mitigate occurrences of the selected candidate NL based responses being difficult to parse, inaccurate, or otherwise not resonating with a user. Put another way, optionally running multiple LLMs in parallel can leverage that different LLMs may perform better in some situations than others, and enables utilizing output from the LLM that is best suited for the current situation.

In some implementations, a user can specify, as part of a query or via interface element(s) in conjunction with a query (e.g., selectable interface element(s) provided near a query input field), desired formatting option(s) for an NL based response. For example, a desired formatting option could be “list format”, “graph format”, “top 5”, “in the style of”, etc. For instance, a query could be “how to draft a patent in our house style, in list format” or “how to draft a patent in our house style, in the style of a layperson”, etc. In some versions of those implementations, the specified format can be used to select an LLM for the selected format. For example, if “list format” is specified, an LLM that is trained a list format prompt can be selected as the LLM to utilize in generating a NL based response according to implementations disclosed herein. In some additional or alternative versions, the specified format can be used to adapt a prompt for an LLM. For example, if “graph” format is specified, a prompt provided to the LLM in generating the NL based response can be e.g., “summarize the following information in graph format”.

Client device 510 can include various user interface components including, for example, microphone(s) to generate audio data based on spoken utterances and/or other audible input, speaker(s) to audibly render synthesized speech and/or other audible output, and/or the display 520 to visually render visual output. Further, the display 520 of the client device 510 can include various system interface elements (e.g., hardware and/or software interface elements) that may be interacted with by a user of the client device 510 to cause the client device 510 to perform one or more actions. The display 520 of the client device 510 enables the user to interact with content rendered on the display 520 by touch input (e.g., by directing user input to the display 520 or portions thereof (e.g., to a query entry box), to a keyboard (not depicted), or to other portions of the display 520)) and/or by spoken input (e.g., by selecting microphone interface element—or just by speaking without necessarily selecting a microphone interface element). Although the client device 510 depicted in FIG. 5 is a mobile phone, it should be understood that is for the sake of example and is not meant to be limiting. For example, the client device 510 may be a standalone speaker with a display, a standalone speaker without a display, a home automation device, an in-vehicle system, a laptop, a desktop computer, and/or any other computing device.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 824 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes receiving a query associated with a client device (e.g., a query submitted based on user interface input at the client device, or a query submitted automatically by the client device or by a server on behalf of the client device). The method further includes generating, by a large language model (LLM), an API query for an external application based on the user query. The external application has access to a custom corpus of documents comprising a plurality of documents. The method further includes querying the external application using the API query. The method further includes receiving, from the external application and in response to the API query, data representative of one or more documents in the custom corpus of documents. The method further includes generating, by the LLM, a response to the user query conditioned on the data representing one or more of the documents in the custom corpus of documents received from the external application. The method further includes causing the response to the user query to be rendered at the client device.

These and other implementations of technology disclosed herein can optionally include one or more of the following features.

In some implementations, generating, by the LLM, an API query for the external application based on the user query includes: selecting, based on the user query, the external application from a plurality of external applications, wherein each external application is associated with a respective custom corpus of documents. In some implementations, selecting the external application from the plurality of external applications is further based on one or more of: a state of the client device; one or more further queries associated with the client device; and/or user data associated with a user of the client device.

In some implementations, generating, by the LLM, an API query for the external application based on the user query includes: generating, by the LLM, a current context vector based on the user query; and generating, by the LLM, the API query based on the context vector.

In some implementations, generating, by the LLM, the current context vector is further based on one or more of: a state of the client device; one or more further queries associated with the client device; and/or user data associated with a user of the client device.

In some implementations, querying the external application using the API query causes the external application to: compare the context vector to a set of precomputed embeddings, each of the precomputed embeddings associated with a respective document in the custom corpus of documents; select, based on the comparison of the context vector to the set of precomputed embeddings, one or more of the documents in the custom corpus of documents; and provide, to the LLM, data representative of the selected one or more documents in the custom corpus of documents.

In some implementations, causing the external application to select, based on the comparison of the context vector to the set of precomputed embeddings, one or more of the documents in the custom corpus of documents causes the external application to: determine a distance between the context vector and each of the precomputed embeddings; and select documents in the custom corpus of documents that are within a threshold distance of the context vector.

In some implementations, causing the external application to select, based on the comparison of the context vector to the set of precomputed embeddings, one or more of the documents in the custom corpus of documents causes the external application to: determine a distance between the context vector and each of the precomputed embeddings; rank the documents in the custom corpus of documents based on the distance between the context vector and the precomputed embedding for each document in the custom corpus of documents; and select the closest pre-defined number of documents from the custom corpus of documents.

In some implementations, the data representative of one or more documents in the custom corpus of documents includes one or more of the documents and/or a portion of one or more of the documents.

In some implementations, causing the response to the user query to be rendered at the client device includes: causing a portion of a document in one or more of the documents to be incorporated into the response to the user query.

In some implementations, the data representative of one or more documents in the custom corpus of documents includes an embedded representation of one or more of the documents.

In some implementations, causing the response to the user query to be rendered at the client device includes: causing a selectable link to one or more of the documents in the custom corpus to be incorporated into the response rendered at the client device.

In some implementations, the method further includes: generating, by the LLM, a further API query for a further external application based on the user query, wherein the further external application has access to a further custom corpus of documents comprising a plurality of further documents. The method may further include receiving, from the further external application and in response to the further API query, further data representative of one or more further documents in the further custom corpus of documents. In some implementations, generating, by the LLM, the response to the user query is further conditioned on the further data representative of one or more of the further documents in the further custom corpus of documents.

In some implementations, the method further includes: determining, by the LLM, whether the user query associated with the client device is directed towards the custom corpus of documents; and in response to a negative determination, generating, by the LLM, the response to the user query without querying the external application.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving a user query associated with a client device;
generating, by a large language model (LLM), an API query for an external application based on the user query, wherein the external application has access to a custom corpus of documents comprising a plurality of documents;
querying the external application using the API query;
receiving, from the external application and in response to the API query, data representative of one or more documents in the custom corpus of documents;
generating, by the LLM, a response to the user query conditioned on the data representing one or more of the documents in the custom corpus of documents received from the external application; and
causing the response to the user query to be rendered at the client device.

2. The method of claim 1, wherein generating, by the LLM, an API query for the external application based on the user query comprises:
selecting, based on the user query, the external application from a plurality of external applications, wherein each external application is associated with a respective custom corpus of documents.

3. The method of claim 2, wherein selecting the external application from the plurality of external applications is further based on one or more of: a state of the client device; one or more further queries associated with the client device; and/or user data associated with a user of the client device.

4. The method of claim 1, wherein generating, by the LLM, an API query for the external application based on the user query comprises:
generating, by the LLM, a current context vector based on the user query; and
generating, by the LLM, the API query based on the context vector.

5. The method of claim 4, wherein generating, by the LLM, the current context vector is further based on one or more of: a state of the client device; one or more further queries associated with the client device; and/or user data associated with a user of the client device.

6. The method of claim 4, wherein querying the external application using the API query causes the external application to:
compare the context vector to a set of precomputed embeddings, each of the precomputed embeddings associated with a respective document in the custom corpus of documents;
select, based on the comparison of the context vector to the set of precomputed embeddings, one or more of the documents in the custom corpus of documents; and
provide, to the LLM, data representative of the selected one or more documents in the custom corpus of documents.

7. The method of claim 6, wherein causing the external application to select, based on the comparison of the context vector to the set of precomputed embeddings, one or more of the documents in the custom corpus of documents causes the external application to:
determine a distance between the context vector and each of the precomputed embeddings; and
select documents in the custom corpus of documents that are within a threshold distance of the context vector.

8. The method of claim 6, wherein causing the external application to select, based on the comparison of the context vector to the set of precomputed embeddings, one or more of the documents in the custom corpus of documents causes the external application to:
determine a distance between the context vector and each of the precomputed embeddings;
rank the documents in the custom corpus of documents based on the distance between the context vector and the precomputed embedding for each document in the custom corpus of documents; and
select the closest pre-defined number of documents from the custom corpus of documents.

9. The method of claim 1, wherein the data representative of one or more documents in the custom corpus of documents comprises one or more of the documents and/or a portion of one or more of the documents.

10. The method of claim 9, wherein causing the response to the user query to be rendered at the client device comprises:
causing a portion of a document in one or more of the documents to be incorporated into the response to the user query.

11. The method of any of claim 1 wherein the data representative of one or more documents in the custom corpus of documents comprises an embedded representation of one or more of the documents.

12. The method of claim 1, wherein causing the response to the user query to be rendered at the client device comprises:
causing a selectable link to one or more of the documents in the custom corpus to be incorporated into the response rendered at the client device.

13. The method of claim 1, further comprising:
generating, by the LLM, a further API query for a further external application based on the user query, wherein the further external application has access to a further custom corpus of documents comprising a plurality of further documents; and
receiving, from the further external application and in response to the further API query, further data representative of one or more further documents in the further custom corpus of documents,
wherein generating, by the LLM, the response to the user query is further conditioned on the further data representative of one or more of the further documents in the further custom corpus of documents.

14. The method of claim 1, further comprising:
determining, by the LLM, whether the user query associated with the client device is directed towards the custom corpus of documents; and
in response to a negative determination, generating, by the LLM, the response to the user query without querying the external application.

15. A system comprising:
one or more processors; and
a memory, the memory storing computer-readable instructions that, when executed by the one or more processors, cause the one or more processors to:
receive a user query associated with a client device;
generate, by a large language model (LLM), an API query for an external application based on the user query, wherein the external application has access to a custom corpus of documents comprising a plurality of documents;
query the external application using the API query;
receive, from the external application and in response to the API query, data representative of one or more documents in the custom corpus of documents;
generate, by the LLM, a response to the user query conditioned on the data representing one or more of the documents in the custom corpus of documents received from the external application; and
cause the response to the user query to be rendered at the client device.

16. A non-transitory computer-readable medium comprising computer-readable instructions that, when executed by one or more processors, cause the one or more processors to perform operations, the operations comprising:
receiving a user query associated with a client device;
generating, by a large language model (LLM), an API query for an external application based on the user query, wherein the external application has access to a custom corpus of documents comprising a plurality of documents;
querying the external application using the API query;
receiving, from the external application and in response to the API query, data representative of one or more documents in the custom corpus of documents;
generating, by the LLM, a response to the user query conditioned on the data representing one or more of the documents in the custom corpus of documents received from the external application; and
causing the response to the user query to be rendered at the client device.
